(19) United States
(12) Patent Application Publication
(10) Pub. No.: US 2021/0238428 A1
(43) Pub. Date: Aug. 5, 2021

(54) NON-AQUEOUS INK COMPOSITIONS

(71) Applicant: Hewlett-Packard Development Company, L.P., Spring, TX (US)

(72) Inventors: Kamila BENNETT, Corvallis, OR (US); Larrie DEARDURFF, Corvallis, OR (US)

(73) Assignee: Hewlett-Packard Development Company, L.P., Spring, TX (US)

(21) Appl. No.: 17/048,689

(22) PCT Filed: Apr. 30, 2018
(86) PCT No.: PCT/US2018/030085

§ 371 Date: Oct. 19, 2020

(51) Int. Cl. C09D 11/033; C09D 11/103; C09D 11/328; C08K 5/05; C08L 71/02

(52) U.S. Cl. CPC C09D 11/033; C09D 11/103; C08L 71/02; C08K 5/05; C09D 11/328

(57) ABSTRACT

The present disclosure is drawn to non-aqueous ink compositions. The non-aqueous ink compositions can include from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye.

### BACKGROUND

Inkjet printing has become a popular way of recording images on various types of media. Some of the reasons include low printer noise, variable content recording, capability of high speed recording, and multi-color recording. These advantages can be obtained at a relatively low price to consumers. As the popularity of inkjet printing increases, the types of uses also increases providing demand for new ink compositions and applications.

### BRIEF DESCRIPTION OF DRAWINGS

FIG. 1 is a diagram showing an example method of printing in accordance with the present disclosure;

FIG. 2 graphically presents example dry times of various ink compositions on a non-porous polymeric substrate in accordance with an example of the present disclosure;

FIG. 3 graphically presents example optical density of various ink compositions on a non-porous polymeric substrate in accordance with an example of the present disclosure; and

FIG. 4 graphically presents example rub-tested fraction fade of various ink compositions on a non-porous polymeric substrate in accordance with an example of the present disclosure.

### DETAILED DESCRIPTION

Inkjet printing on non-porous polymeric substrates can present challenges due to the low surface energy of the substrate and because these types of substrates tend to resist fluid penetration. This can be particularly prevalent when the non-porous polymeric substrate has not first been surface treated to make the substrate more susceptible to ink adhesion. The term “untreated” indicates that a printing surface of a non-porous polymeric substrate has not been mechanically or chemically modified, such as by mechanical or chemical abrasion or by the application of a chemical ink receiving coating, for example. In some examples, the non-porous polymer substrates can be materials such as polyolefins, which lack functional groups that may otherwise aid in the adhesion of ink to the substrate. Printing solutions including the addition of volatile solvents and resins can be ineffective, whereas the use of high concentrations of resins with more aggressive solvents can provide some adhesion, but may tend to degrade the materials used to make the inkjet architecture operate properly and/or can lead to poor decap performance due to the high concentration of solids. On the other hand, with the inclusion of a certain class of resin as described in further detail herein, inkjet printing on non-porous polymeric substrates with low surface energy can occur with acceptable dry time, optical density, and durability, for example.

In accordance with this, the present disclosure relates generally to a non-aqueous ink composition, a printing system, and a method of printing. In one example, the non-aqueous ink composition can include from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye. In one example, the alcohol solvent can be methanol, ethanol, n-propanol, isopropanol, n-butanol, isobutanol, tert-butanol, or a mixture thereof. In another example, the phenol-formaldehyde resin can include a C3 to C8 alkyl-modified phenol-formaldehyde resin. The phenol-formaldehyde resin can have a formaldehyde to phenol molar ratio of less than one, meaning there can be more phenol groups than formaldehyde groups by polymerized monomeric unit by total number. In one specific example, the phenol-formaldehyde resin can be present at from 1.5 wt % to 5.2 wt %. In another example, the phenol-formaldehyde resin can have a weight average molecular weight ranging from 1,000 Mw to 3,500 Mw. Regarding the perfluoropolyether in particular, the non-aqueous ink composition can be prepared with from 0.05 wt % to 0.9 wt % of a perfluoropolyether-dissolving cosolvent in addition to alcohol solvent. The perfluoropolyether-dissolving cosolvent can include, for example, hexane, ethyl acetate, acetone, or a mixture thereof. In further detail, the perfluoropolyether can be a dialkyl amide perfluoropolyether.

In another example, a printing system can include a non-aqueous ink composition and a non-porous polymeric substrate. The non-aqueous ink composition can include from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye. In one example, the non-porous polymer substrate can be untreated, such as by mechanical or chemical surface modification. In further detail, the non-porous polymer substrate can have a low surface energy, which can be defined as surface energies ranging from 18 mN/m to 35 mN/m. In other examples, the non-porous polymeric substrate can be biaxially oriented, such as biaxially oriented polypropylene. In another example, the phenol-formaldehyde resin can include a C3 to C8 alkyl-modified phenol-formaldehyde resin.

In another example, a method of printing can include ejecting a non-aqueous ink composition onto a non-porous polymeric substrate. The non-aqueous ink composition can include from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye. In one example, the non-porous polymeric substrate can be untreated and can have a surface energy from 18 mN/m to 35 mN/m.

In another example, the phenol-formaldehyde resin can include a C3 to C8 alkyl-modified phenol-formaldehyde resin and the perfluoropolyether can include a dialkyl amide perfluoropolyether.

It is noted that when discussing the non-aqueous ink composition, the printing system, and the method of printing, these various discussions can be considered applicable to other examples whether or not they are explicitly discussed in the context of that example. Thus, for example, in discussing an alcohol solvent related to a non-aqueous ink composition, such disclosure is also relevant to and directly supported in context of the printing system, the method of printing, vice versa, etc.

The term “phenol-formaldehyde resin” is used herein to refer to a genus or series of resins that include alternating moieties of various phenols (modified or unmodified) and methylene (—CH₂— provided by the formaldehyde) groups, e.g., phenol-methylene-phenol-methylene, etc. One specific type of phenol-formaldehyde resin is a novolac resin that starts and ends the polymer chain with a phenol moiety (consuming the formaldehyde during polymerization and often leaving excess unreacted phenols in the reaction mixture. Phenol-formaldehyde resins can be linked together at the ortho position or the para position relative hydroxyl group positioned on the aromatic ring. Modification to the phenol group, e.g., a C3 to C8 alkyl group, can likewise typically be at the ortho or para position. To avoid confusion, the specific polymer species commonly referred to as “phenol-formaldehyde” is but one specific species of a phenol-formaldehyde resin as defined herein, e.g., the unmodified variety of the resin. Like any of the phenol-formaldehyde resins, they can have a variety molecular weight based on chain length, but in the case of modified phenol-formaldehyde resins, the molecular weight can also be increased per unit or “mer” along the polymer chain due to other side groups that are also positioned on the aromatic ring of the phenol in addition to the hydroxyl group. Thus, the term “phenol-formaldehyde resin(s)” refers to the genus of polymers that can be modified or unmodified at the phenol group, and the terms “phenol-formaldehyde” or “unmodified phenol-formaldehyde resin” refer more specifically to phenol-formaldehydes with only hydrogen at the remaining available ortho-, meta-, and para-positions (after polymerization).

As mentioned, the non-aqueous ink composition can include an alcohol solvent. In one example, the alcohol solvent can be present in the formulation at from 70 wt % to 98 wt %, from 75 wt % to 85 wt %, from 80 wt % to 90 wt %, from 70 wt % to 80 wt %, or from 90 wt % to 98 wt %. The alcohol can serve as the primary solvent in the composition and can decrease dry time of a printed article created with the ink compositions and non-porous polymeric substrates of the present disclosure. In one example, the alcohol solvent can include a C1 to C4 alcohol. These alcohols can include methanol, ethanol, n-propanol, isopropanol, cyclopropanol, butanol, n-butanol, 2-butanol, isobutanol, tert-butanol, cyclobutanol, or mixtures thereof. C1 to C4 alcohol solvents used herein, for example, can be less aggressive than other types of solvents and may not degrade materials often found in inkjet architecture. C1 to C4 alcohols can also improve dry time and provide enhanced solubility of various components. In some examples, the alcohol solvent can be denatured. In other examples, the alcohol solvent can be a straight chain alcohol. In other examples, the alcohol solvent can be branched, e.g., isopropanol or one of the branched butanols. In one example, the alcohol solvent can include ethanol. In yet another example, the alcohol solvent can include n-propanol.

The ink compositions can also include from 1 wt % to 6 wt % of a phenol-formaldehyde resin. An example of a commercially available phenol-formaldehyde resin that can be used in the ink compositions herein is REACTOL™ 1111E (LAWTER™, Inc., Illinois), which is non-reactive and highly soluble in C1-C4 alcohols, e.g., >1% solubility in ethanol. In one specific example, the phenol-formaldehyde resin can have a softening point temperature from 135° C. to 180° C., from 135° C. to 160° C., or from 140° C. to 170° C., for example, which can be established using the ASTM E28-14 protocol known as the “ring and ball” test. In further detail, the phenol-formaldehyde resin can be present in the ink composition at from 1.5 wt % to 5.2 wt %. In another example, the phenol-formaldehyde resin can be present in the ink composition at from 1 wt % to 4 wt %. In some examples, the phenol-formaldehyde resin can have a weight average molecular weight ranging from 1,000 Mw to 3,500 Mw, from 1,000 Mw to 3,000 Mw, from 1,000 Mw to 2,600 Mw, or from 1,800 Mw to 2,600 Mw. As phenol is aromatic, the phenol-formaldehyde resin includes aromatic moieties. In one example, the phenol-formaldehyde resin can be considered highly aromatic, which can be defined as including 85 wt % to 95 wt % or from 87 wt % to 93 wt % polymerized aromatic monomer. When the phenol-formaldehyde resin is a C3 to C8 alkyl-modified phenol-formaldehyde with the 1,000 Mw to 3,500 Mw range described above, the monomer weight can be from 87 wt % to 93 wt polymerized aromatic monomer, for example. It is noted that the phenol moiety can be modified with other groups other than C3 to C8 alkyl groups, e.g., alicyclic groups, oxygen-modified side groups, nitrogen-modified side groups, sulfur-modified side groups, etc. Additionally, the C3 to C8 alkyl group can be straight chained or branched. In one example, the C3 to C8 alkyl group can be at the para-position and can be branched, e.g., para-tert-butylphenol-formaldehyde and the polymerization can occur at the ortho position (both ortho positions occupied for polymerization except for at the end units where only one position may be occupied).

The phenol-formaldehyde resin can be a novolac resin. Novolac resins can be prepared without excess of formaldehyde so that formaldehyde is consumed during the polymerization process. Because the phenol groups react with the formaldehyde groups at typically the para- or ortho-position and not with other phenol groups, the polymer formed includes alternating phenol-containing units (formed from the phenol group) and —CH₂— units (formed from the formaldehyde). As all of the formaldehyde groups are consumed, the end units of the polymer can both be provided by the phenol-containing group, e.g., phenol-CH₂-phenol-CH₂-phenol-CH₂-phenol, etc., beginning and ending with phenol moieties. Thus, in one example, the phenol-formaldehyde resin can have a formaldehyde to phenol molar ratio of less than one. In other examples, excess formaldehyde that is not part of the resin can be excluded or essentially excluded from the ink composition, as it can be used up during the formation of the phenol-formaldehyde resin. Without the presence of excess formaldehyde, this can prevent the novolac resin from curing in the ink composition.

The inclusion of a phenol-formaldehyde resin in the ink compositions described herein can benefit from the durability enhancement and dry time reduction when printed on a non-porous polymeric substrate. These benefits in combination were not found to be achievable with some other types of polymers, such as tosylamide-epoxy resin, ethylcellulose, polyvinyl-butyral resin, tosylamide-formaldehyde resin, or polyvinyl acetate, none of which resist removal from untreated biaxially oriented polypropylene non-porous substrates in response to surface rub that may be common when handling printed substrates. In one example, this durability enhancement provided by the phenol-formaldehyde resins may be attributable to non-covalent interactions between the phenol-formaldehyde resin and the non-porous media, such as hydrogen donation from the polymeric substrate, e.g., polyolefin, to an aromatic ring of a phenol-formaldehyde resin, which may result in the formation of C—H/π interactions.

The ink compositions can further include from 1 wt % to 14 wt % of an organic solvent-soluble dye. As used herein, “organic solvent-soluble dye” refers to a dye that is soluble in an organic solvent or cosolvent, e.g., the alcohol solvent and/or cosolvent. The organic solvent-soluble dye can be soluble in either or both types of solvent (alcohol solvent and/or organic cosolvent) prior to mixing together or after mixing together, depending on the methodology. The organic solvent-soluble dye can be present in the ink composition at from 3 wt % to 12 wt % or from 5 wt % to 10 wt %. In some examples the organic solvent-soluble dye can be a black dye. Other colors can include cyan dye, magenta dye, yellow dye, orange dye, red dye, pink dye, blue dye, violet dye, green dye, brown dye, etc. In other examples, a combination of organic solvent-soluble dyes can be incorporated into the ink composition. For example, the organic solvent-soluble dye could be the combination of a black dye and an orange dye, which can be included to provide a more neutral black ink color.

Commercially available organic solvent-soluble dyes can include BASONYL® blue 636, ORASOL® black X55, ORASOL® black SBK28, ORASOL® black SBK27, ORASOL® black SBK29, ORASOL® blue 825, ORASOL® blue 855, ORASOL® orange 247, ORASOL® orange 251, ORASOL® orange 272, ORASOL® orange 347, ORASOL® pink 478, ORASOL® red 330, ORASOL® red 355, ORASOL® red 363, ORASOL® red 365, ORASOL® red 395, ORASOL® red 471, ORASOL® yellow 075, ORASOL® yellow 152, and ORASOL® yellow 157 all available from BASF, Germany; MORFAST® brown 100 and NAVIPON® violet 9 available from Sunbelt Corporation, South Carolina; ORASOL® yellow 2RLN available from Ciba Specialty Chemicals, Switzerland; SAVINYL® black RLSN, SAVINYL® blue RS, and SAVINYL® red 3GLS all available from Clariant Ltd, Texas; and VALIFAST® black 3804, VALIFAST® black 3807, VALIFAST® black 3820, VALIFAST® black 3830, VALIFAST® black 3840, VALIFAST® black 3866, VALIFAST® black 3870, VALIFAST® blue 1605, VALIFAST® blue 1613, VALIFAST® blue 1621, VALIFAST® blue 1631, VALIFAST® blue 2606, VALIFAST® blue 2620, VALIFAST® blue 2670, VALIFAST® brown 2402, VALIFAST® brown 3402, VALIFAST® brown 3405, VALIFAST® green 1501, VALIFAST® orange 1201, VALIFAST® orange 2210, VALIFAST® orange 3208, VALIFAST® orange 3209, VALIFAST® orange 3210, VALIFAST® pink 2310N, VALIFAST® pink 2312, VALIFAST® red 1308, VALIFAST® red 1320, VALIFAST® red 1355, VALIFAST® red 1364, VALIFAST® red 1388, VALIFAST® red 2303, VALIFAST® red 2320, VALIFAST® red 3304, VALIFAST® red 3306, VALIFAST® red 3311, VALIFAST® red 3312, VALIFAST® red 3320, VALIFAST® violet 1701, VALIFAST® violet 1704, VALIFAST® yellow 1101, VALIFAST® yellow 1109, VALLIFAST® yellow 109, VALLIFAST® yellow 1151, VALLIFAST® yellow 1171, VALLIFAST® yellow 3108, VALLIFAST® yellow 3120, VALLIFAST® yellow 3150, VALLIFAST® yellow 3170, VALLIFAST® yellow 3180, VALLIFAST® yellow 4120, and VALLIFAST® yellow 4141 all available from Orient Chemical Industries, California.

In some examples, the ink composition can further include other solid or liquid components. For example, the ink composition can further include from 2 wt % to 12 wt % of an organic cosolvent (other than the alcohol solvent component). In yet other examples, the composition can include from 3 wt % to 9 wt % organic cosolvent, or from 4 wt % to 11 wt % organic cosolvent. In one example, the organic cosolvent can include C4 to C8 aliphatic hydrocarbon chain(s). To illustrate using hexane as an example, the hexane can be n-hexane, a branched isomer thereof, or a mixture of hexane isomers. Isomers of hexane can include, for example, n-hexane, cyclohexane, and branched hexane isomers (2-methylpentane; 3-methylpentane; 2,3 dimethylbutane; 2,2 dimethylbutane, etc.). The organic cosolvent can include a carbonyl functional group, a ketone functional group, an ester functional group, or a combination thereof. The cosolvent may likewise include ethyl acetate or acetone, for example.

In another example, the ink composition can further include from 0.05 wt % to 1 wt % (or alternatively from 0.05 wt % to 0.9 wt %, from 0.05 wt % to 0.8 wt %, or from 0.1 wt % to 0.8 wt %) of a perfluoropolyether. Perfluoropolyethers can have a positive impact on decap performance and can also reduce ink puddling when dispensing solvent-based inks that are described herein. For example, by adding a perfluoropolyether to non-aqueous ink compositions with alcohol solvent, organic solvent-soluble dye, and a phenol-formaldehyde resin as set forth herein can improve decap performance substantially in some examples. For example, decap performance at 15 minutes for an ink composition with even a small amount of added perfluoropolyether in some instances can outperform similar non-aqueous ink compositions without the perfluoropolyether at as short as 10 seconds.

In one specific example, the perfluoropolyether can be a dialkyl amide perfluoropolyether, e.g., a perfluoropolyether backbone with ends functionalized with an alkyl amide group. A commercially available example of a dialkyl amide perfluoropolyether is FLUOROLINK® A10 or A10P (the pelletized version of A10), available from Solvay (Belgium). In some examples, perfluoropolyethers can benefit from the presence of a perfluoropolyether-dissolving organic cosolvent (or “dissolving cosolvent”), such as from 2 wt % to 12 wt % of hexane, ethyl acetate, acetone, or a mixture thereof. Other dissolving cosolvents can be used as well. The perfluoropolyether can be admixed/dissolved in the dissolving cosolvent prior to admixing with the alcohol solvent and the phenol-formaldehyde resin, for example, or it can be admixed after alcohol solvent is present.

One example, as mentioned previously as a dialkyl amide perfluoropolyether, can have number-average molecular weight from 400 daltons to 4000 daltons. One example structural formula can be represented as Formula I, as follows:

X—CF₂—(O—CF₂—CF₂)ₙ—(O—CF₂)ₘ—O—CF₂—X Formula I

where X can be —CONH—(C₉ to C₃₂ alkyl), e.g., C₁₈H₃₇, n can be from 1 to 53, and m can be from 31 to 1, for example. The C₉ to C₃₂ alkyl group can be different for the X on individual ends of the polymer. Furthermore, the C₉ to C₃₂ alkyl can be straight-chained or branched. In some examples, shorter or longer dialkyl amide perfluoropolyether chains can be used, but in more specific examples, m and n can be such that the number-average molecular weight can be from 1200 daltons to 2300 daltons, from 1200 daltons to 2000 daltons, from 2000 daltons to 2500 daltons, 2100 daltons to 2300 daltons, etc.

Turning to the non-porous polymeric substrate, the term “non-porous” does not infer that the substrate is devoid of any and all pores in every case, but rather indicates that the substrate does not permit bulk transport of a fluid through the substrate. In some examples, a non-porous substrate can permit very little water absorption, at or below 0.1 vol %. In yet another example, a non-porous substrate can allow for gas permeability. In one example, however, a non-porous substrate can be substantially devoid of pores. In another example, the non-porous polymeric substrate can be uncoated or without surface treatment. Non-porous substrates can be continuous non-fibrous structures. Non-limiting examples of non-porous polymeric substrates include polyvinyl chloride, polyethylene, low density polyethylene (density less than 0.93 g/cm³), high density polyethylene (density from 0.93 g/cm³ to 0.97 g/cm³), polyethylene terephthalate, polypropylene, polystyrene, polylactic acid, polytetrafluoroethylene (e.g., TEFLON® from the Chemours Company), or blends thereof. In some examples, the non-porous polymeric substrate can be a biaxially-oriented substrate. In a more specific example, the non-porous polymeric substrate can be a biaxially-oriented polypropylene film.

In one example, the non-porous polymeric substrate can be “untreated,” which includes both a lack of any chemical treatment, etching, coating, etc., as well as a lack of any specific mechanical treatment to modify the surface thereof, such as patterning, roughening, etc., in order to make the non-porous polymeric substrate more receptive to the ink composition. Furthermore, when referring to “untreated” substrates, this can also include non-porous polymeric substrates that can lack functional groups at a print surface that can aid in adhesion of ink to the substrate. For example, the non-porous polymeric substrate can be a polyolefin, such as a polyethylene or a polypropylene. In another example, the non-porous polymeric substrate can be a biaxially oriented polyolefin, such as a biaxially oriented polypropylene or other polyolefin. In another example, the non-porous polymeric substrate can be a polytetrafluoroethylene (e.g., TEFLON® from the Chemours Company). Polymer blends of these and other materials can also be used. If “untreated,” these materials can be unmodified chemically and/or mechanically at a surface of the substrate as well as unmodified along the polymer chain of the material at the surface.

In some examples, the non-porous polymeric substrate can also have low surface energy. For example, the substrate can have a surface energy ranging from 18 mN/m to 35 mN/m. In yet other examples, the substrate can have a surface energy ranging from 20 mN/m to 30 mN/m or from 25 mN/m to 35 mN/m. When untreated, in particular, the lack of functional groups along the polymer, the lack of surface modification of the substrate, and the low surface energy of the print surface can make this type of substrate difficult to print upon, as most ink compositions do not adhere well thereon.

“Surface energy” can be evaluated and quantified using contact angle measurement (goniometry) of a liquid applied to the surface of the polymer. The device used for taking the static contact angle measurement can be an FTA200HP or an FTA200, from First Ten Angstroms, Inc. (USA). For example, Young's equation (γ=γₛₗ+γₗᵥ cos θ; where θ is the contact angle, γ is the solid surface free energy, γₛₗ is the solid/liquid interfacial free energy, and γₗᵥ is the liquid surface free energy) can be used to calculate the surface energy from measured contact angle using a dyne fluid, e.g., water. However, in some instances where water is not a good dyne fluid for a particular test, other fluids, such as methylene iodide, ethylene glycol, formamide, etc., can be used to probe the surface generally or to probe different types of surface energy components while avoiding fluids that may dissolve or absorb into the surface. With polymer or non-porous substrates of the present disclosure, the dyne fluid selection generally provides very similar results that may be averaged to the extent there is some degree of different data. In addition to these considerations, dyne fluids can be with known surface tension properties in a controlled atmosphere. In other words, by using dyne fluid(s) (liquid) and atmosphere (gas) with known free energies, and by measuring the contact angle (acute angle between the flat surface and the relative angle at the base of liquid where it contacts the flat surface) of the liquid bead on the polymer surface, these three pieces of data can be used with Young's equation to determine the surface energy of the polymer surface.

Preparation of the non-aqueous ink compositions described herein can be carried by combining from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye. Even if prepared in stages, these weight percentages can be based on the final non-aqueous ink composition. For example, preparation can include dissolving the perfluoropolyether in a perfluoropolyether-dissolving organic cosolvent, and dissolving the phenol-formaldehyde resin in the alcohol solvent at a 1:3 to 1:20 weight ratio. The organic solvent-soluble dye can be added at any stage, e.g., to the alcohol solvent, perfluoropolyether-dissolving organic cosolvent, before or after dissolving the perfluoropolyether, before or after dissolving the phenol-formaldehyde resin, after all other ingredients are combined, etc. In one example, dissolving the phenol-formaldehyde resin in the alcohol solvent can occur after a portion or all of the alcohol solvent has already been admixed with the perfluoropolyether and the perfluoropolyether-dissolving cosolvent. In another example, adding the organic solvent-soluble dye can occur after the perfluoropolyether is admixed with the alcohol solvent, either before or after the phenol-formaldehyde resin has been admixed with the perfluoropolyether.

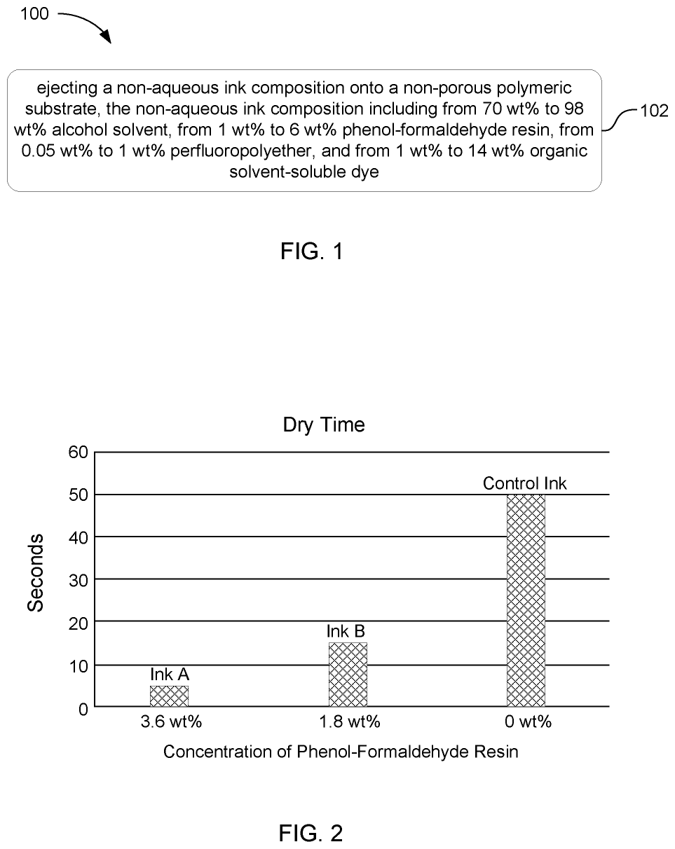

In further detail, and as shown in FIG. 1, a method 100 of printing can include ejecting 102 a non-aqueous ink composition onto a non-porous polymeric substrate. The non-aqueous ink composition can include from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye. In one example, the non-porous polymeric substrate can be untreated and can have a surface energy from 18 mN/m to 35 mN/m. In another example, the phenol-formaldehyde resin can include a C3 to C8 alkyl-modified phenol-formaldehyde resin and the perfluoropolyether can include a dialkyl amide perfluoropolyether.

It is noted that, as used in this specification and the appended claims, the singular forms “a,” “an,” and “the” include plural referents unless the content clearly dictates otherwise.

As used herein, “decap” refers to the ability of a non-aqueous ink composition to readily eject from a print head upon prolonged exposure to air. For example, decap can refer to the amount of time that a print head may be left uncapped before the printer nozzles no longer fires properly, potentially because of clogging or plugging, e.g., 5 second decap, 60 second decap, 5 minute decap, 15 minute decap, 1 hour decap, etc. If a nozzle has become clogged, ink droplets ejected through the nozzle's orifice may be misdirected, which may adversely affect print quality. Thus, decap performance can be evaluated by printing sample print plots including various types of “fill,” such as solid fill, fine lines, grids, etc.

As used herein, a “biaxially-oriented” substrate refers to a substrate that has a stretched crystal or structural orientation in at least two directions or axes. This process can generate non-porous polymeric films that can have a higher tensile strength (per given thickness), greater stiffness, enhanced fluid barrier, etc. Biaxially-oriented substrates can have less permeability and can thereby limit diffusion compared to other types of substrates. Because these substrates tend to have enhanced fluid barrier properties, printing on biaxially-oriented substrates can be particularly challenging in some examples.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of 1 wt % to 20 wt % should be interpreted to include not only the explicitly recited limits of 1 wt % and 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following illustrates examples of the present disclosure. However, it is to be understood that these examples are only illustrative of the principles set forth herein. Numerous modifications may be devised without departing from the disclosure teachings. The appended claims are intended to cover such modifications. Thus, while the technology has been described above with particularity, the following provides further detail in connection with what are presently deemed to be the acceptable examples.

### Example 1—Non-Aqueous Ink Composition

Several different non-aqueous ink compositions were formulated. A dialkyl amide perfluoropolyether was dissolved in ethyl acetate, cyclohexanone, and/or acetone. Ethanol was then added, followed by the addition of a phenol-formaldehyde resin (Inks A and B, but not in Control Ink), and lastly the dye to generate non-aqueous Ink A, non-aqueous Ink B, and a non-aqueous Control Ink. These ink composition formulations are reproduced in Table 1, as follows:

TABLE 1
Non-Aqueous Ink Compositions

| | | | | Control |
|---|---|---|---|---|
| | | Ink A | Ink B | Ink |
| Component | Type | (wt %) | (wt %) | (wt %) |
| Ethanol | Alcohol Solvent | 86.3 | 70.1 | 76.2 |
| Cyclohexanone | Cosolvent | — | — | 9 |
| Acetone | Cosolvent | — | — | 6 |
| Ethyl acetate | Cosolvent | 5 | 10 | — |
| FLUOROLINK ® | Decap Additive | 0.3 | 0.3 | 0.3 |
| A10P | | | | |
| NEOCRYL ® B818 | Acrylic | — | — | 1.8 |
| | copolymer | | | |
| VALIFAST ® 3808 | Organic solvent- | 4.8 | 9 | 4.8 |
| | soluble dye | | | |
| ORASOL ® | Organic solvent- | — | — | 0.9 |
| Orange 347 | soluble dye | | | |
| CRODAFOS ™ T6A | Emulsifier/ | — | — | 1.0 |
| | Surfactant | | | |
| REACTOL ™ 1111E | Phenol- | 3.6 | 1.8 | — |
| | formaldehyde | | | |
| | resin | | | |

FLUOROLINK ® A10P is a dialkyl amide perfluoropolyether from Solvay, Belgium.
NEOCRYL ® B818 is an alcohol soluble acrylic copolymer from Fitz Chem, Illinois.
VALIFAST ® 3808 is a solvent-soluble black dye from Orient Chemical Industries, California.
ORASOL ® Orange 347 is a solvent-soluble orange dye from BASF, Germany.
CRODAFOS ™ T6A is a POE isotridecyl phosphate emulsifier/surfactant from Prospector, N. America.
REACTOL ™ 1111E is a phenol-formaldehyde resin from Lawter, Inc., Illinois.

### Example 2—Dry Time on Biaxially Oriented Polypropylene

Inks A and B and the Control Ink were tested for dry time. The testing involved printing a rectangular block of each ink on untreated biaxially-oriented polypropylene film using a Motiv6 HP® ink jet printer. The untreated biaxially-oriented polypropylene film had a surface energy of about 30-32 mNm. The amount of time that passed for the ink to dry to the touch was recorded.

As can be seen in FIG. 2, Ink A and Ink B took significantly less time to dry than the Control Ink. Ink A, which included 3.6 wt % phenol-formaldehyde resin, dried in 5 seconds. Ink B, which incorporated 1.8 wt % phenol-formaldehyde resin, dried in 15 seconds. Both are reasonable dry times. The Control Ink, which excluded the phenol-formaldehyde resin, dried in 50 seconds.

### Example 3—Optical Density on Biaxially Oriented Polypropylene

The prints prepared in Example 2 were tested for optical density (KOD). Once the print was generated on the untreated biaxially-oriented polypropylene film, the ink compositions were allowed to rest for two hours. A SPECTROLINO® D50 (Gretag-Macbeth AG Joint Stock Corp., Switzerland) light source was utilized to measure the optical density of the various prints.

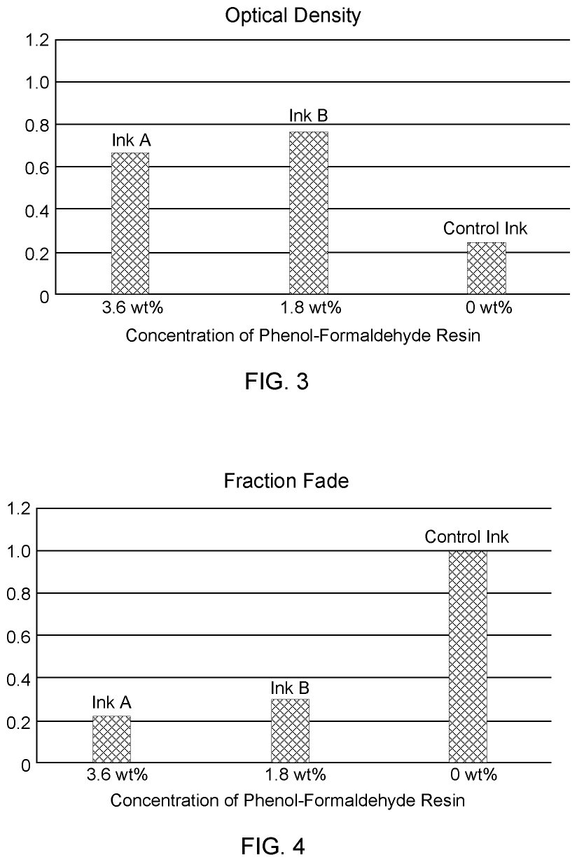

As can be seen in FIG. 3, the prints created from Ink A and Ink B exhibited significantly better optical density than the print created from the Control Ink. The print created from Ink A which incorporated 3.6 wt % phenol-formaldehyde resin had an optical density of 0.68, the print created from Ink B which incorporated 1.8 wt % phenol-formaldehyde resin had an optical density of 0.77, and the print created from the Control Ink which excluded the phenol-formaldehyde resin had an optical density of 0.25.

### Example 4—Fraction Fade—Durability on Biaxially Oriented Polypropylene

Following measuring of the optical density, the prints were then tested for fraction fade. A rub-tester, TMI® (Testing Machines Inc., New York) model #10-1801-0001 was fitted with a blue latex glove having one drop squalene oil applied at the tip. Each print was rubbed 24 times in three spots at a pressure of 30 psi. The prints were then scanned using an EPSON® V5000 Office Scanner (Seiko Epson Corp., Japan) and the percent fade was calculated by dividing the optical density of the rubbed area by the optical density of the areas that were not rubbed. The percent fade was calculated using QEA® IAS 2000-D software (Quality Engineering Associates, Inc., Massachusetts).

The results of the rub test are shown in FIG. 4, identified in terms of “fraction fade” of the prints. Thus, the lower the number the better, as it indicates less optical density reduction as a result of the rub test. Ink A and Ink B had better rub resistance durability or fraction fade compared to the Control Ink. More specifically, the print generated on the biaxially oriented polypropylene non-porous substrate using Ink A, which incorporated 3.6 wt % phenol-formaldehyde resin, had a fraction fade of 0.22. Ink B, which incorporated 1.8 wt % phenol-formaldehyde resin, had a fraction fade of 0.30. The Control Ink, which included no phenol-formaldehyde resin, had a fraction fade of 1, meaning all of the ink composition where rubbed was essentially removed and the non-porous surface was no longer obscured by the ink composition previously printed thereon.

### Example 5—Optical Density and Wipe Performance on Polytetrafluoroethylene

Ink A and the Control Ink from Table 1 (Example 1) were printed on a non-porous polytetrafluoroethylene substrate, e.g., TEFLON® from the Chemours Company, in a similar manner as that described in Example 2. The surface energy of the polytetrafluoroethylene substrate was 18 mN/m. Ink A exhibited an optical density of 0.41, whereas the Control Ink provided an optical density of about 0.21. After about 5 seconds of dry time, the Control Ink could be wiped cleanly from the TEFLON® surface, whereas Ink A had the appearance of being completely dry and could not be wiped away from the TEFLON® surface under the same wiping conditions, e.g., swiping a latex gloved finger across the printed block about 3-5 seconds after printing

### Example 6—Decap Performance

A comparative non-aqueous ink composition (Control Ink 2) with alcohol solvent, organic solvent-soluble dye, and phenol-formaldehyde was prepared to compare the decap performance to Inks A and B of Table 1. Control Ink 2 was prepared without any added dialkyl amide perfluoropolyether (FLUOROLINK® al OP). Table 2 provides the formulation for Control Ink 2.

TABLE 2
Decap Comparative Non-aqueous Ink Composition (Control Ink 2)

| | | Control Ink 2 |
|---|---|---|
| Component | Type | (wt %) |
| Ethanol | Alcohol Solvent | 93.4 |
| VALIFAST ® 3808 | Organic solvent- | 4.8 |
| | soluble dye | |
| REACTOL ™ 1111E | Phenol- | 1.80 |
| | formaldehyde | |
| | resin | |

VALIFAST ® 3808 is a solvent-soluble black dye from Orient Chemical Industries, California.
REACTOL ™ 1111E is a phenol-formaldehyde resin from Lawter, Inc., Illinois.

Decap was tested for the three inks (Ink A, Ink B, and Control Ink 2) at four time periods (left uncapped), e.g., 10 seconds, 60 seconds, 5 minutes, and 15 minutes. After the uncapped time period, or decap time, sample print plots were prepared for the various inks, for a total of twelve (12) sample print plots. The print plots include solid printed portions, regions with fine vertical stripes, and regions with rectangular grids. The printhead used for the testing was a thermal inkjet printhead with 600 total nozzles (300 odd and 300 even) sized at about 30 microns in diameter per nozzle. The printhead was set to 300 drops per inch and the print speed was set to run at about 40 inches per second using even nozzles. To prepare the printheads for evaluation, the three inks were individually loaded in respective print cartridges and the printhead fired so that all of the nozzles ejected ink. The printhead was then left uncapped for the various time periods set forth above.

Evaluation of the sample decap print plots, which compared Ink A, Ink B, and Control Ink 2, revealed that decap performance for both Inks A and B was very good at all 4 time periods, even 15 minutes, with Ink A slightly outperforming Ink B at the longest decap time tested. These two inks performed nearly identically at 10 seconds, 60 seconds, and 5 minutes. Control Ink 2, on the other hand, exhibited unacceptable decap performance at all four time periods of decap, with performance deteriorating incrementally at the various time frames from 10 seconds to 15 minutes. Both Inks A and B performed significantly better at 15 minutes compared to the 10 second performance of Comparative Ink 2.

While the present technology has been described with reference to certain specific examples, various modifications, changes, omissions, and substitutions can be made without departing from the disclosure. It is intended, therefore, that the disclosure be limited only by the claims.

What is claimed is:

1. A non-aqueous ink composition, comprising:
from 70 wt % to 98 wt % alcohol solvent;
from 1 wt % to 6 wt % phenol-formaldehyde resin;
from 0.05 wt % to 1 wt % perfluoropolyether; and
from 1 wt % to 14 wt % organic solvent-soluble dye.

2. The non-aqueous ink composition of claim 1, wherein the alcohol solvent is methanol, ethanol, n-propanol, isopropanol, cyclopropanol, n-butanol, 2-butanol, isobutanol, tert-butanol, cyclobutanol, or a mixture thereof.

3. The non-aqueous ink composition of claim 1, wherein the phenol-formaldehyde resin includes a C3 to C8 alkyl-modified phenol-formaldehyde resin.

4. The non-aqueous ink composition of claim 1, wherein the phenol-formaldehyde resin has a formaldehyde to phenol molar ratio of less than one.

5. The non-aqueous ink composition of claim 1, wherein the phenol-formaldehyde resin is present at from 1.5 wt % to 5.2 wt % and has a weight average molecular weight ranging from 1,000 Mw to 3,500 Mw.

6. The non-aqueous ink composition of claim 1, further comprising from 2 wt % to 12 wt % of perfluoropolyether-dissolving cosolvent in addition to alcohol solvent.

7. The non-aqueous ink composition of claim 6, wherein the perfluoropolyether-dissolving cosolvent includes hexane, ethyl acetate, acetone, or mixture thereof.

8. The non-aqueous ink composition of claim 1, wherein the perfluoropolyether is a dialkyl amide perfluoropolyether.

9. A printing system, comprising:
a non-aqueous ink composition, including from 70 wt % to 98 wt % alcohol solvent,
from 1 wt % to 6 wt % phenol-formaldehyde resin,
from 0.05 wt % to 1 wt % perfluoropolyether, and
from 1 wt % to 14 wt % organic solvent-soluble dye; and
a non-porous polymeric substrate.

10. The printing system of claim 9, wherein the non-porous polymeric substrate is untreated and has a surface energy from 18 mN/m to 35 mN/m.

11. The printing system of claim 10, wherein the non-porous polymeric substrate is a biaxially oriented polypropylene.

12. The printing system of claim 9, wherein the phenol-formaldehyde resin includes a C3 to C8 alkyl-modified phenol-formaldehyde resin.

13. A method of printing, comprising ejecting a non-aqueous ink composition onto a non-porous polymeric substrate, the non-aqueous ink compositing, comprising from 70 wt % to 98 wt % alcohol solvent, from 1 wt % to 6 wt % phenol-formaldehyde resin, from 0.05 wt % to 1 wt % perfluoropolyether, and from 1 wt % to 14 wt % organic solvent-soluble dye.

14. The method of claim 13, wherein the non-porous polymeric substrate is untreated and has a surface energy from 18 mN/m to 35 mN/m.

15. The method of claim 13, wherein the phenol-formaldehyde resin includes a C3 to C8 alkyl-modified phenol-formaldehyde resin and the perfluoropolyether includes a dialkyl amide perfluoropolyether.
